(19) United States
(12) Patent Application Publication
(10) Pub. No.: US 2009/0132593 A1
(43) Pub. Date: May 21, 2009

(54) Media player for playing media files by emotion classes and method for the same

(75) Inventor: Xie Lv, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 12/122,690

(22) Filed: May 17, 2008

(30) Foreign Application Priority Data
Nov. 15, 2007 (CN) 200710177434.9

(51) Int. Cl. G06F 17/30

(52) U.S. Cl. 707/104.1; 707/E17.009

(57) ABSTRACT

Techniques for playing back media files based on their classified emotion classes are disclosed. According to one aspect of the present invention, media files, downloaded or pre-stored, are classified in accordance with a set of emotion classes. Upon receiving a playback instruction from a user, a play-back system (e.g., an audio/video player) is caused to look up one or more of the media files classified in the one of the emotion classes corresponding to the instruction. These selected files are then decoded and played back.

### BACKGROUND OF THE INVENTION

1. Field of the Invention

The present invention relates to the area of playback of media files, and more particularly to techniques for playing media files based on their classified emotion classes.

2. Description of Related Art

With continuous development of multimedia techniques, media players are widely used. FIG. 1 is a block diagram schematically showing a conventional media player. The conventional media player includes a central controller 101, a media file library 102, an audio decoder 103 and an audio output unit 104.

The central controller 101 is configured for responding to an inputted custom instruction to output at least one media file corresponding to the custom instruction to the audio decoder 103. The media file library 102 is configured for storing a plurality of media files.

The audio decoder 103 is configured for decoding the received media file from the media file library 102 and outputting the decoded audio data to the audio output unit 104. The audio output unit 104 is configured for playing the decoded audio data.

It can be seen that the conventional media player plays the media file by looking up, audio decoding and outputting the media file. However, a requirement from a user to play back a media file may be subject to his/her emotion at the time of playing back the media file. For example, the user may want to play different media files in accordance with his/her mode or the circumstance he/she is with. Thus, the conventional media player can not satisfy the requirement of the user.

Thus, there is a need for improved techniques for playing media files by their classified emotion classes to enhance the availability of the media player.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention is related to techniques for playing back media files based on their classified emotion classes. According to one aspect of the present invention, media files, downloaded or pre-stored, are classified in accordance with a set of emotion classes. Upon receiving a playback instruction from a user, a play-back system (e.g., an audio/video player) is caused to look up one or more of the media files classified in the one of the emotion classes corresponding to the instruction. These selected files are then decoded and played back.

To proper classify the medial files, a music emotion classifying unit is configured to distill from the medial files some music basic elements including speed, intensity, rhythm, melody, and tone color and match the music basic elements with a set of preset psychology models. An emotion class for each of the media files is based on a psychology model matched with the music basic elements. Further a mapping relation between an emotion class and a media file is retained. Depending on the mapping relation between the emotion classes and the media files, a media player can realize the function of playing back media files by their corresponding emotion classes.

One of the features, benefits and advantages in the present invention is to provide techniques for playing back media files based on their classified emotion classes.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a block diagram schematically showing a conventional media player;

FIG. 2 is a block diagram schematically showing a media player for playing media files by their emotion classes according to one embodiment of the present invention;

FIG. 3 is a block diagram schematically showing a media player for playing media files by their emotion classes according to another embodiment of the present invention;

FIG. 4 is a flowchart schematically showing a method for playing media files by their emotion classes according to one embodiment of the present invention; and

FIG. 5 is a flowchart schematically showing a method for classifying media files by emotion according to one embodiment of the present invention.

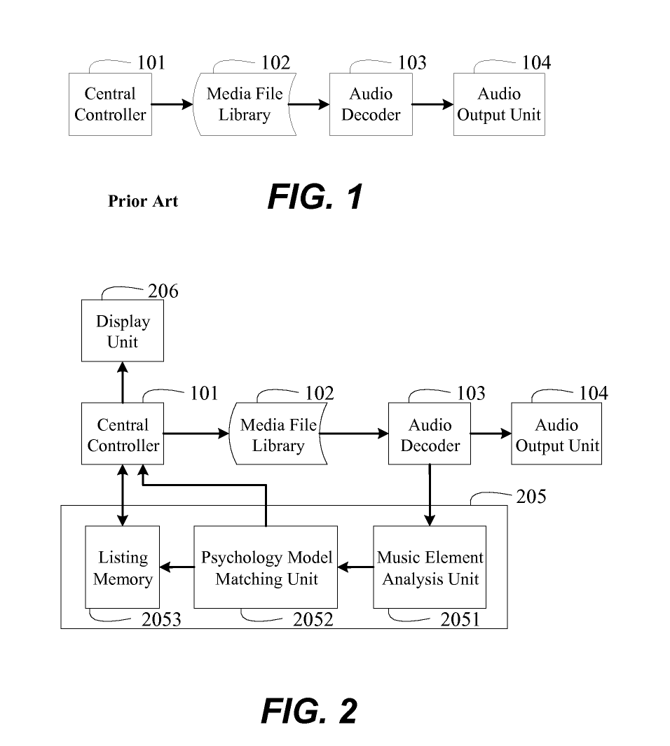

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

Embodiments of the present invention are discussed herein with reference to FIGS. 2-5. However, those skilled in the art will readily appreciate that the detailed description given herein with respect to these figures is for explanatory purposes only as the invention extends beyond these limited embodiments.

According to one embodiment of the present invention, a media player is configured for receiving a user instruction and decoding/playing one or more media files classified in an emotion class corresponding to the instruction. First, the media files should be classified into appropriate emotion classes, wherein the emotion classes may include blue, passion and cantabile etc. For example, a user may input one instruction according to his current feeling or a circumstance he is with. Assuming it indicates that he wants to listen to passion music, the media player plays the media file classified in a corresponding passion class.

According to one embodiment, media files pre-stored or downloaded may be classified as follows: decoding a media file; analyzing the decoded media file to get some music basic elements including speed, intensity, rhythm, melody, tone color etc.; matching the music basic elements of the media file with preset psychology models to obtain a psychology model matched with the music basic elements; determining an emotion class of the media file based on the matched psychology model. The preset psychology models may include a number of classes (e.g., a passion psychology model, a cantabile psychology model and a blue psychology model, wherein each psychology model corresponds to an emotion class).

FIG. 2 is a block diagram showing a media player for playing media files by their emotion classes according to one embodiment of the present invention. Referring to FIG. 2, the media player comprises a central controller 101, a media file library 102, an audio decoder 103, an audio output unit 104, a music emotion classifying unit 205 and a display unit 206.

The central controller 101 is configured for receiving a user instruction corresponding to one emotion class, getting the media files having the emotion class corresponding to the instruction from the media file library 102. The media file library 102 is configured for storing a plurality of media files and outputting the media files having the emotion class corresponding to the instruction to the audio decoder 103. In some cases, the display unit 206 is configured for displaying the media files having the emotion class corresponding to the instruction for the customers. Thus, the customers can further determine to play one or more of the media files having the emotion class corresponding to the instruction.

The audio decoder 103 is configured for decoding the received media files and outputting the decoded audio data to the music emotion classifying unit 205 or the audio output unit 104. The music emotion classifying unit 205 is configured for analyzing the decoded audio data to assign one emotion class to the media file and outputting the classification result to the central controller 101. The audio output unit 104 is configured for playing the decoded audio data received from the audio decoder 103. As a result, the media player can play the media files by their emotion classes.

In operation, the central controller 101, the audio decoder 103 and the music emotion classifying unit 205 needs to cooperate with each other to classify the media files in the media file library 102 by emotion previously. The central controller 101 outputs the media files in the media file library 102 to the audio decoder 103 in turn. The audio decoder 103 decodes the received media files and outputs the decoded media files to the music emotion classifying unit 205. The music emotion classifying unit 205 distills some music basic elements including speed, intensity, rhythm, melody, tone color from each decoded media file, matches the music basic elements of each of the media files with the preset psychology models, determines the emotion class of each of the media files based on the psychology model matched with the music basic elements, and stores a mapping relation between the emotion classes and the media files. Depending on the mapping relation between the emotion classes and the media files, the media player shown in FIG. 2 can realize the function of playing the media files by their emotion classes.

Referring to FIG. 2, the music emotion classifying unit 205 in one embodiment may includes a music element analysis unit 2051, a psychology model matching unit 2052 and a listing memory 2053.

The music element analysis unit 2051 is configured for distilling some music basic elements such as speed, intensity, rhythm, melody, tone color from one decoded media file and outputting the music basic elements of the media file and an identifier of the media file to the psychology model matching unit 2052. In one embodiment, the psychology model matching unit 2052 has a plurality of preset psychology models, such as the blue psychology model, the passion psychology model and the cantabile psychology model. The psychology model matching unit 2052 is configured for matching the music basic elements of the media file with the preset psychology models to determine the emotion class of the media file based on the psychology model matched with the music basic elements and outputting the emotion class and the identifier of the media file to the listing memory 2053.

Each psychology model includes a number of basic music elements assigned with different values. Hence, if the basic music elements of the media file are extracted, the psychology model matched with the media file can be determined by comparing the basic music elements of the media file with that of the psychology models. In practice, if the correlation degree between the basic music elements of one media file and that of one psychology model is larger than a preset threshold, namely the correlation degree between the media file and the psychology model is larger than the preset threshold, it can be concluded that the psychology model is matched with the media file. For example, provided that the correlation degree between the basic music elements of one media file 1 and that of one psychology model A is 90%, the preset threshold is 60%, 90%>60%, so it can be concluded that the psychology model A is matched with the media file 1.

The listing memory 2053 is configured for storing a class listing recording the emotion class of each media file. In one embodiment, the psychology model matching unit 2052 may also output the correlation degree between the media file and the psychology model to the listing memory 2053. Accordingly, the class listing in the listing memory 2053 may also record the correlation degree between the media file and corresponding emotion class.

In one embodiment, the psychology model matching unit 2052 may also output the emotion class and the identifier of the media file to the central controller 101. In this case, the central controller 101 may be provided for forwarding the emotion class and the identifier of the media file to the listing memory 2053. In another embodiment, it should be noted that the emotion class of the media file may be directly added into attributes of a corresponding media file in the media library by the central controller 101.

Thus, when receiving a user instruction corresponding to an emotion class, the central controller 101 can output the media files in the media file library 102 having the emotion class corresponding to the instruction depending on the class listing in the listing memory 2053.

Provided that there is a blue psychology model, the passion psychology model and the cantabile psychology model in the psychology model matching unit 2052, which corresponds to the blue emotion class, passion emotion class and the cantabile emotion class, respectively. After receiving the instruction indicating that the customer want to listen to the blue music, the central controller 101 may look up the media file identifier corresponding to the blue emotion class in the listing memory 2053, and transfer the media files corresponding to the media file identifier to the audio decoder 103. The audio decoder 103 decodes the received media files and outputs the decoded audio data to the audio output unit 104. The audio output unit 104 plays the received audio data. As a result, the media files having the blue emotion class are played by the media player.

In one embodiment, a user instruction may correspond to plural emotion classes, or may indicate that the user wants to listen to the media files randomly. In this case, in order to inform the customer of the emotion class of the media files currently playing, the display unit 206 is provided to display the information about the emotion class of the media files currently being played. As mentioned above, the listing memory 2053 may further store the correlation degree between the media file and corresponding emotion class. Hence, the display unit 206 may also display the correlation degree between the emotion class and the media play currently being played.

As described above, the media player provided in the present invention can play one or more emotion class of media files satisfying a user requirement according to an instruction provided by the user, thereby diversifying the playing function of the media player and enhancing the availability of the media player.

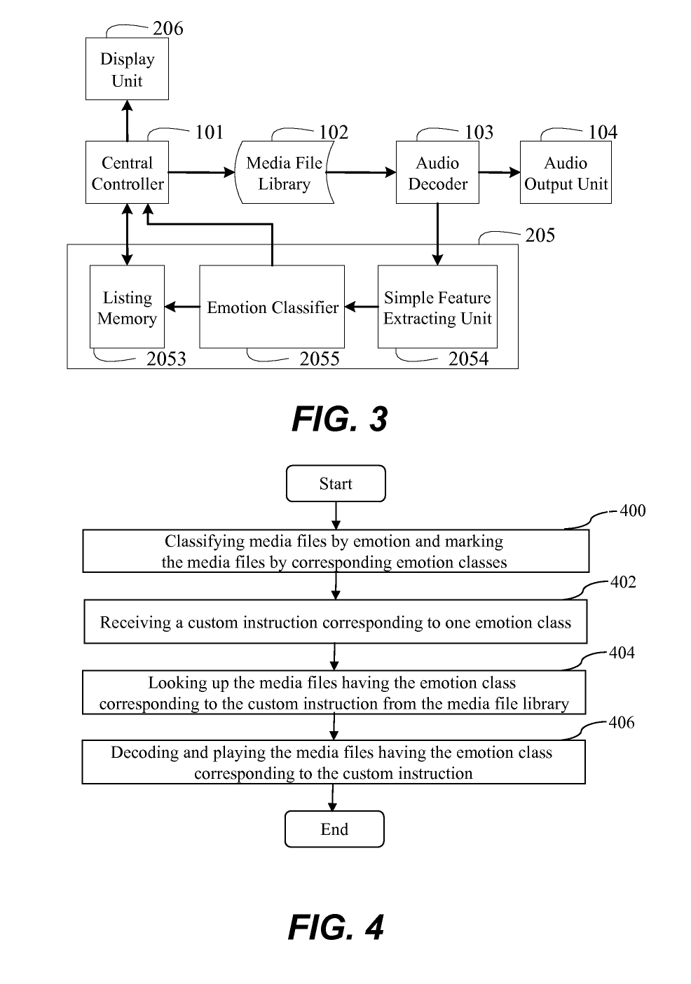

Referring to FIG. 3, which shows the media player according to another embodiment of the present invention, the media player is identical with that shown in FIG. 2 except for the music emotion classifying unit 205. In another embodiment, the music emotion classifying unit 205 shown in FIG. 3 comprises a simple feature extracting unit 2054, an emotion classifier 2055 and a listing memory 2053.

The simple feature extracting unit 2054 is configured for extracting simple features, instead of the basic music elements, from the decoded media files. The simple features may comprise energy measurement in a short period, an average magnitude in a short period and a spectrum feature in a short period etc. The emotion classifier 2055 may be one of intelligence classifiers having learning ability such as an Artificial Neural Network (ANN) classifier or a Hidden Markov Model (HMM) classifier.

As it is known to ordinary people skilled in the art, the training operation should be performed beforehand in order to put the learning ability on the intelligence classifier. In one embodiment, the operation includes selecting a plurality of media files; determining corresponding psychology model of each media file by technicians in the art; regarding the media files having corresponding determined psychology models as training samples; extracting simple features of each training sample and inputting the simple features to the intelligence classifier; setting the determined psychology model of each training sample as the expected output of the intelligence classifier; calculating parameters of the intelligence classifier according to a given learning rule in order to ensure the factual output of the intelligence classifier near to the expected output. Thus, the intelligence classifier completes its learning operation.

After being trained, the intelligence classifier can be provided for classifying the media files by emotion classes. The simple feature extracting unit 2054 receives the decoded media files from the audio decoder 103, extracts the simple features from the decoded media files, and outputs the simple features to the emotion classifier 2055. The emotion classifier 2055 is configured for analyzing the received simple features of each media file according to the parameters calculated in the training operations, and outputting corresponding psychology model of the simple features of each media file. Additionally, the emotion classifier 2055 may also output the correlation degree between the media file and the matched psychology model.

The emotion classifier 2055 can further determine the emotion class of each media file based on the psychology model matched with the media file. Finally, the emotion classifier 2055 output the emotion class and the identifier of corresponding media file to the listing memory 2053 or the central controller 101.

For further understand the present invention, the method for playing the media files by the emotion class is described hereafter. Referring to FIG. 4, the method comprises the following operations.

At 400, the media files are classified by emotion and marked with corresponding emotion classes.

At 402, the media player receives the custom instruction corresponding to one emotion class from the external interface.

At 404, the media player looks up the media files having the emotion class corresponding to the custom instruction from the media file library 102.

At 406, the media player decodes and plays the media files having the emotion class corresponding to the custom instruction. At the same time, the emotion class of the media file currently playing is displayed on the display unit 206.

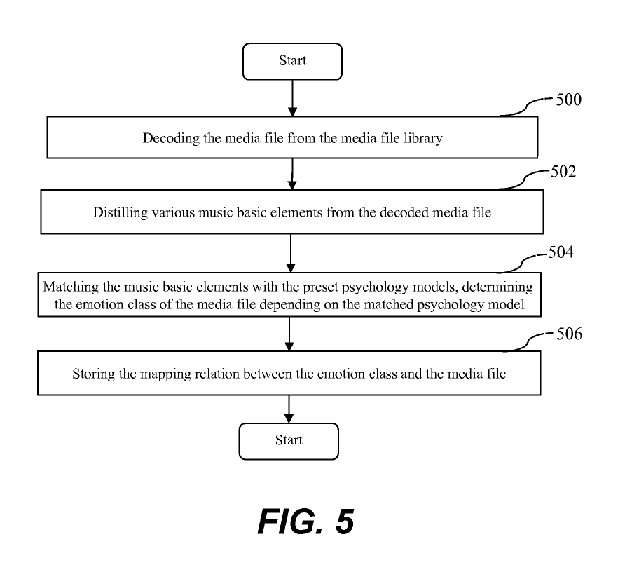

FIG. 5 is a flowchart schematically showing a method for classifying the media file by emotion. Referring to FIG. 5, the method comprises the following operations.

At 500, the media file from the media file library is decoded.

At 502, various music basic elements are distilled from the decoded media file. The music basic elements includes speed, intensity, rhythm, melody, tone color etc. The rhythm is taken as an example for further explanation hereafter.

At 502a, the decoded audio data is received by frames, a current frame of decoded audio data (including 1024 samples in time domain) is transformed by Fast Fourier Transform Algorithm (FFT) to transform the audio data from time domain to frequency domain. Thus, the audio signal in frequency domain aₙ+jbₐ is got, wherein n is a positive integer larger than or equal to zero, and less than or equal to 511.

At 502b, the amplitude A[n]=\sqrt{aₙ²+bₙ²} of the audio signal in frequency domain is calculated.

At 502c, the audio signal in frequency domain is divided into multiple sub-bands according to frequency, such as 50˜200, 200˜400, 400˜800, 800˜1600, 1600˜3200, above 3200 Hz respectively. The amplitude of each sub-band signal is calculated and regarded as the transient energy.

In practice, the transient energy is calculated according to the following equation.

$$EI [ i ] = \frac{1}{{W}_{i}} {\sum }_{n = {S}_{i}}^{{S}_{i + 1}} A [ n ] ,$$

wherein EI[i] indicates the transient energy of the ith sub-band, Wᵢ indicates the width of the ith sub-band, Sᵢ indicates the initial line of the ith sub-band, and i is a positive integer large than 1.

After 502c is performed, the transient energy of every sub-band of current frame is stored. At the same time, the transient energy of every sub-band of previous frame firstly stored is deleted according to first in first out rule.

At 502d, the transient energy variance EV[i] and the transient energy average EA[i] of the transient energies EI[i] of the ith sub-band of m frames are calculated according to the following equation.

$$EA [ i ] = \frac{1}{m} {\sum }_{j = 0}^{m - 1} {EI}_{j} [ i ] , \\ EV [ i ] = \frac{1}{m} {\sum }_{j = 0}^{m - 1} {( {EI}_{j} [ i ] - EA [ i ] )}^{2} ,$$

wherein m indicates the number of the frame buffering in a frame buffer, EIⱼ[i] indicates the transient energy of the ith sub-band of the jth frame.

At 502e, determining if the transient energy EI[i] of each sub-band of current frame is peak value according to the transient energy variance EV[i] and the transient energy average EA[i]. If yes, the transient energy EI[i] determined to be the peak value is extracted as the rhythm in the music basic elements. when EI[i] is larger than C×EA[i] and EV[i] is larger than V, the EI[i] is determined to be the peak energy, wherein C and V is a constant determined in test, C=250, V=150 generally.

At 504, the music basic elements distilled from the media file are matched with the preset psychology models, the psychology model matched with the music basic elements are determined as the emotion class of the media file.

At 506, the mapping relation between the emotion class and the media file is stored in the listing memory 2053.

As a result, one or more emotion class of media files satisfying the customer's requirement can be played, thereby diversifying the playing function of the media player and enhancing the availability of the media player.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. A method for playing back media files, the method comprising:
classifying the media files into classes of emotion;
receiving a user instruction corresponding to one of the emotion classes;
looking up one of the media files classified in the one of the emotion classes corresponding to the instruction; and
decoding and playing back the one of the media files.

2. The method according to claim 1, wherein the classifying the media files into classes of emotion comprises:
decoding the media files;
distilling music basic elements from each of the decoded media files;
matching the music basic elements of each of the decoded media files with a plurality of preset psychology models; and
determining one of the emotion classes for each of the media file based on a matched psychology model.

3. The method according to claim 2, wherein the classifying the media files into classes of emotion further comprises:
marking the media files in accordance with one of the corresponding emotion classes; or
storing respective mapping relations between the emotion classes and the media files.

4. The method according to claim 2, wherein the music basic elements comprises speed, intensity, rhythm, melody and tone color.

5. The method according to claim 2, wherein the matching the music basic elements of each of the decoded media files with a plurality of preset psychology models comprises:
calculating a correlation degree between each of the basic music elements of the one of the media files and each of the preset psychology models;
determining a psychology model having a highest correlation degree with a media file or a psychology model having a highest correlation degree with the media file larger than a threshold as the matched psychology model.

6. The method according to claim 5, further comprising:
storing the correlation degree between the basic music elements of the media file and the matched psychology models.

7. The method according to claim 2, wherein each of the psychology models corresponds to one emotion class.

8. The method according to claim 2, wherein the preset psychology models comprises a blue psychology model, a passion psychology model and a cantabile psychology model.

9. The method according to claim 1, wherein the classifying the media files into classes of emotion comprises:
decoding the media files from the media file library;
extracting simple features from each decoded media file;
analyzing simple features of each media file by an intelligence classifier to output one matched psychology model; and
determining the emotion class of each media file based on the matched psychology model.

10. The method according to claim 9, wherein the simple features comprises a short time energy, a short time average magnitude or a short time spectrum feature.

11. The method according to claim 9, wherein the intelligence classifier is an Artificial Neural Network (ANN) classifier or a Hidden Markov Model (HMM) classifier.

12. The method according to claim 9, wherein before being used for classifying the media files by emotion, the intelligence classifier is trained by a plurality of training samples.

13. A method for playing back media files, the method comprising:
a media file library configured for storing a plurality of media files;
an audio decoder configured for decoding the media files from the media library;
a music emotion classifying unit configured for analyzing the decoded media files to assign one emotion class to each of the media files;
a central controller configured for receiving a user instruction corresponding to an emotion class, getting a set of the media files classified into the emotion class corresponding to the instruction.

14. The media player according to claim 13, wherein the music emotion classifying unit comprises:
a music element analysis unit configured for distilling music basic elements from the decoded media file;
a psychology model matching unit configured for matching the music basic elements of the media file with preset psychology models, and determining the emotion class of the media file based on the matched psychology model.

15. The media player according to claim 13, wherein the music emotion classifying unit comprises:
a simple feature extracting unit configured for extracting simple features from the decoded media file;
an emotion classifier configured for analyzing the simple features of the media file to output one matched psychology model, and determining the emotion class of the media file based on the matched psychology model.

16. The media player according to claim 13, wherein the music emotion classifying unit comprises:
a listing memory configured for storing emotion class of each media file.

17. The media player according to claim 14, wherein the psychology model matching unit is configured further for calculating a correlation degree between the basic music elements of the media file and the preset psychology models, and determining the psychology model having highest correlation degree with the media file or the psychology model having the correlation degree with the media file larger than a threshold as the matched psychology model.

18. The media player according to claim 14, wherein the music basic elements comprises speed, intensity, rhythm, melody or tone color.
